(19) United States
(12) Patent Application Publication
(10) Pub. No.: US 2015/0317330 A1
(43) Pub. Date: Nov. 5, 2015

(54) STORING DATA TO MULTIPLE STORAGE LOCATION TYPES IN A DISTRIBUTED HISTORIZATION SYSTEM

(71) Applicant: Invensys Systems, Inc., Foxboro, MA (US)

(72) Inventors: Alexander Vasilyevich Bolotskikh, Ladera Ranch, CA (US); Yevgeny Naryzhny, Foothill Ranch, CA (US); Vinay T. Kamath, Rancho Santa Margarita, CA (US); Abhijit Manushree, Laguna Niguel, CA (US)

(73) Assignee: Invensys Systems, Inc., Foxboro, MA (US)

(21) Appl. No.: 14/704,666

(22) Filed: May 5, 2015

Related U.S. Application Data
(60) Provisional application No. 61/988,731, filed on May 5, 2014.

(51) Int. Cl. G06F 17/30

(52) U.S. Cl. CPC G06F 17/30194

(57) ABSTRACT

A system for historizing process control data. A historian storage module receives data to be stored and determines a storage type of the received data. The historian storage module loads an abstraction layer module with the received data and the determined storage type. The abstraction layer module determines a storage type interface that matches the received storage type from one or more storage type interfaces. The abstraction layer module formats the received data to the matching storage type interface and determines a storage location that matches the received storage type. The abstraction layer module sends the formatted data to be stored at the matching storage location via the matching storage type interface.

### CROSS REFERENCE TO RELATED APPLICATIONS

This application claims priority of Naryzhny et al., U.S. provisional application Ser. No. 61/988,731 filed on May 5, 2014, entitled “Distributed Historization System.” The entire contents of the above identified application are expressly incorporated herein by reference, including the contents and teachings of any references contained therein.

### BACKGROUND

Aspects of the present invention generally relate of the fields of networked computerized industrial control, automation systems and networked computerized systems utilized to monitor, log, and display relevant manufacturing/production events and associated data, and supervisory level control and manufacturing information systems. Such systems generally execute above a regulatory control layer in a process control system to provide guidance to lower level control elements such as, by way of example, programmable logic controllers or distributed control systems (DCSs). Such systems are also employed to acquire and manage historical information relating to processes and their associated outputs. More particularly, aspects of the present invention relate to systems and methods for storing and preserving gathered data and ensuring that the stored data is accessible when necessary. “Historization” is a vital task in the industry as it enables analysis of past data to improve processes.

Typical industrial processes are extremely complex and receive substantially greater volumes of information than any human could possibly digest in its raw form. By way of example, it is not unheard of to have thousands of sensors and control elements (e.g., valve actuators) monitoring/controlling aspects of a multi-stage process within an industrial plant. These sensors are of varied type and report on varied characteristics of the process. Their outputs are similarly varied in the meaning of their measurements, in the amount of data sent for each measurement, and in the frequency of their measurements. As regards the latter, for accuracy and to enable quick response, some of these sensors/control elements take one or more measurements every second. Multiplying a single sensor/control element by thousands of sensors/control elements (a typical industrial control environment) results in an overwhelming volume of data flowing into the manufacturing information and process control system. Sophisticated data management and process visualization techniques have been developed to store and maintain the large volumes of data generated by such system.

It is a difficult but vital task to ensure that the process is running efficiently. An aspect of the present invention is a system that stores data from multiple sources and enables access to the data in multiple locations and forms. The system provides interfaces to enable the storage of data in a variety of storage types.

### SUMMARY

Aspects of the present invention relate to a system that stores data from multiple sources and enables access to the data in multiple locations and forms. The system simplifies the process of interfacing with multiple types of storage locations.

In one form, a system historizes process control data. The system has a historian storage module and an abstraction layer module. The system also comprises one or more storage locations. The historian storage module receives data to be stored and determines the storage type of the received data. The historian storage module loads the abstraction layer module with the received data and the determined storage type. The abstraction layer module has access to implementations of one or more storage type interfaces. The abstraction layer module receives the data to be stored and storage type from the historian storage module. The abstraction layer module determines a storage type interface which matches the received storage type from the one or more storage type interfaces. The abstraction layer module formats the received data to the matching storage type interface. The abstraction layer module determines a storage location which matches the received storage type from the one or more storage locations. The abstraction layer module sends the formatted data to be stored at the matching storage location via the matching storage type interface.

In another form, a method is provided.

Other features will be in part apparent and in part pointed out hereinafter.

### BRIEF DESCRIPTION OF THE DRAWINGS

FIG. 1 is a diagram detailing an architecture of a historian system according to an embodiment of the invention.

FIG. 2 is an exemplary diagram of a historization workflow performed by the system of FIG. 1.

FIG. 3 is an exemplary diagram of the structure of the system of FIG. 1.

FIG. 4 is an exemplary diagram of a Historization System Abstraction Layer (HSAL) workflow according to an embodiment of the invention.

FIG. 5 is an exemplary diagram of the HSAL operating in a worker role for cloud storage according to an embodiment of the invention.

FIG. 6 is an exemplary diagram of the HSAL operating in a worker role for on premise storage according to an embodiment of the invention.

FIG. 7 is an exemplary diagram of cloud historian abstraction layers generally according to an embodiment of the invention.

FIG. 8 is an exemplary diagram of the cloud historian abstraction layers when connected to a cloud data source according to an embodiment of the invention.

FIG. 9 is an exemplary diagram of the cloud historian abstraction layers when connected to an on premises data source according to an embodiment of the invention.

Corresponding reference characters indicate corresponding parts throughout the drawings.

### DETAILED DESCRIPTION

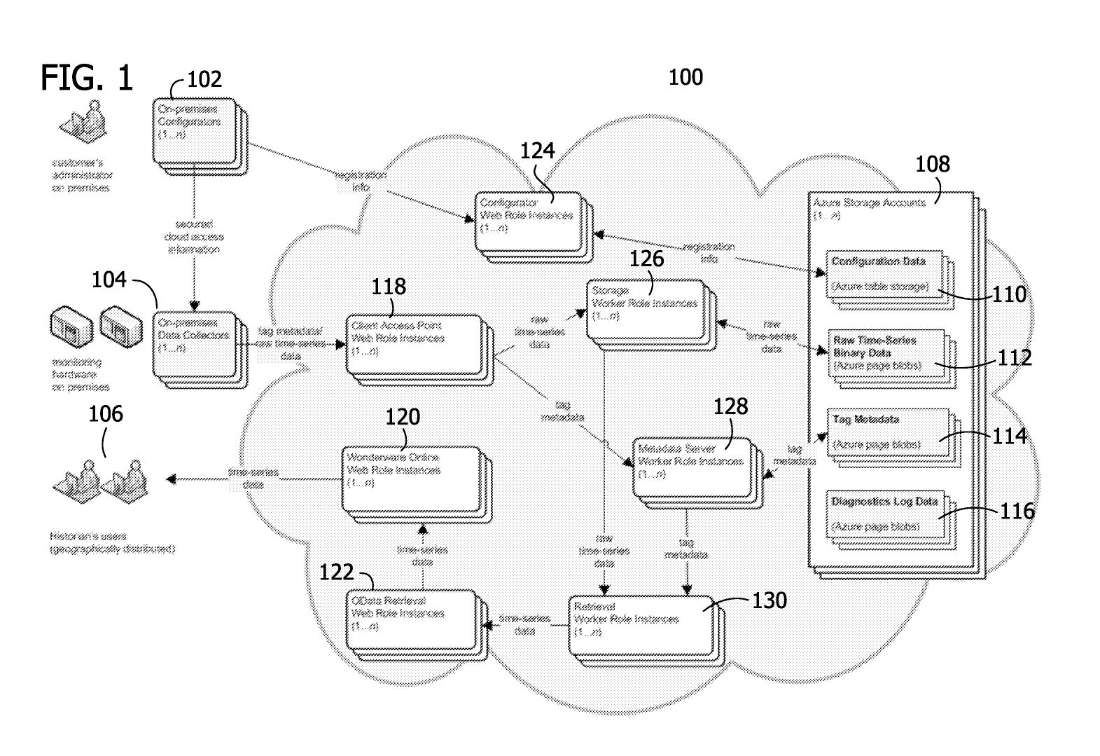

Referring to FIG. 1, a distributed historian system, generally indicated at 100, enables users to log into the system to easily view relationships between various data, even if the data is stored in different data sources. The historian system 100 can store and use data from various locations and facilities and use cloud storage technology to ensure that all the facilities are connected to all the necessary data. The system 100 forms connections with configurators 102, data collectors 104, and user devices 106 on which the historian data can be accessed. The configurators 102 are modules that may be used by system administrators to configure the functionality of the historian system 100. The data collectors 104 are modules that connect to and monitor hardware in the process control system to which the historian system 100 is connected. The data collectors 104 and configurators 102 may be at different locations throughout the process control system. The user devices 106 comprise devices that are geographically distributed, enabling historian data from the system 100 to be accessed from various locations across a country or throughout the world.

In an embodiment, historian system 100 stores a variety of types of information in storage accounts 108. This information includes configuration data 110, raw time-series binary data 112, tag metadata 114, and diagnostic log data 116. The storage accounts 108 may be organized to use table storage or other configuration, such as page blobs.

In an embodiment, historian system 100 is accessed via web role instances. As shown, configurators 102 access configurator web role instances 124. And data collectors 104 access client access point web role instances 118. Online web role instances 120 are accessed by the user devices 106. The configurators 102 share configuration data and registration information with the configurator web role instances 124. The configuration data and registration information is stored in the storage accounts 108 as configuration data 110. The data collectors 104 share tag metadata and raw time-series data with the client access point web role instances 118. The raw time-series data is shared with storage worker role instances 126 and then stored as raw time-series binary data 112 in the storage accounts 108. The tag metadata is shared with metadata server worker role instances 128 and stored as tag metadata 114 in the storage accounts 108. The storage worker role instances 126 and metadata server worker role instances 128 send raw time-series data and tag metadata to retrieval worker role instances 130. The raw time-series data and tag metadata is converted into time-series data and sent to the online web role instances 120 via data retrieval web role instances 122. Users using the user devices 106 receive the time-series data from the online web role instances 120.

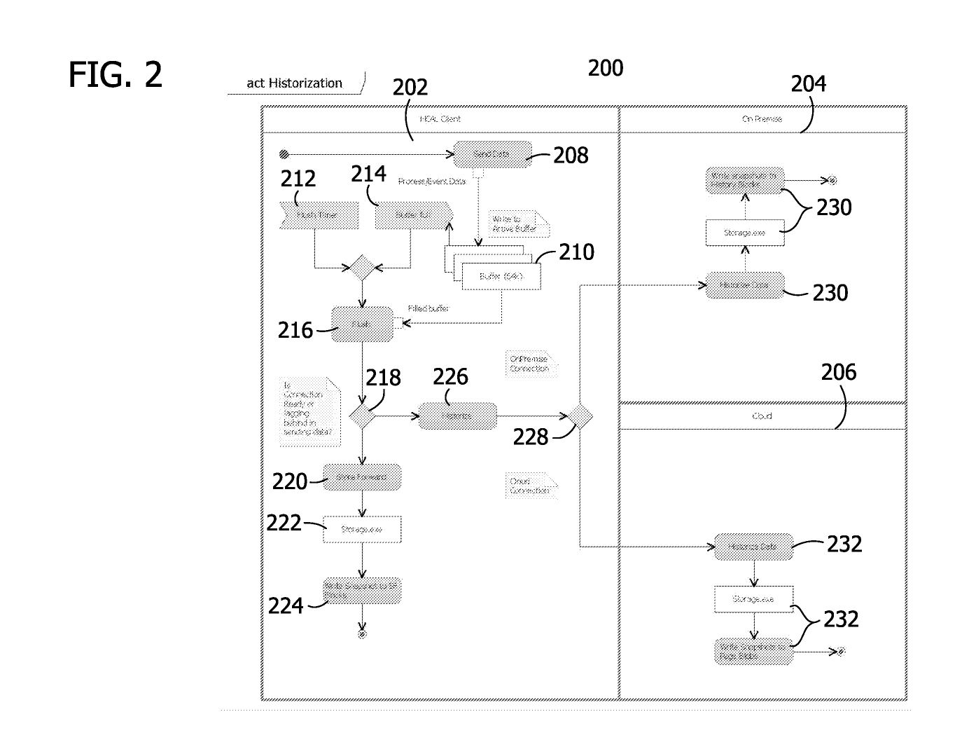

FIG. 2 describes a workflow 200 for historizing data according to the described system. The Historian Client Access Layer (HCAL) 202 is a client side module used by the client to communicate with historian system 100. The HCAL 202 can be used by one or more different clients for transmitting data to historian system 100. The data to be sent 208 comes into the HCAL 202 and is stored in an active buffer 210. The active buffer 210 has a limited size. When the active buffer is full 214, the active buffer is “flushed” 216, meaning it is cleared of the data and the data is sent to historian 100. There is also a flush timer 212 which will periodically cause the data to be sent from the active buffer 210, even if the active buffer 210 is not yet full.

When historizing 226, the data may be sent to a historian that is on premises 204 or a historian that stores data in the cloud 206 (step 228). The HCAL 202 treats each type of historian in the same way. However, the types of historians may store the data in different ways. In an embodiment, the on-premises historian 204 historizes the data by storing the data as files in history blocks 230. The cloud historian 206 historizes the data by storing the data in page blobs 232, which enable optimized random read and write operations.

In the event that the connection between HCAL 202 and the historian 204 or 206 is not working properly, the flushed data from the active buffer 210 is sent to a store forward module 220 on the client (step 218). The data is stored 222 in the store forward module 220 in the form of snapshots written to store forward blocks 224 until the connection to the historian is functional again and the data can be properly transmitted. The store forward module 220 may also get rid of data after a certain period of time or when it is full. In those cases, it will send an error to the system to indicate that data is not being retained.

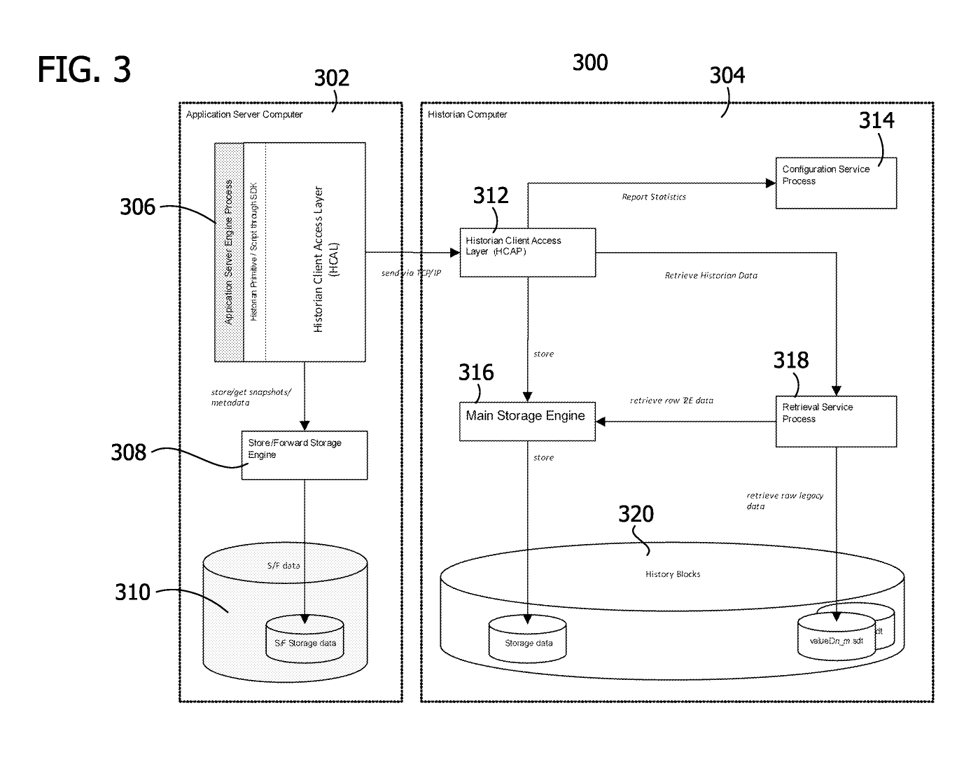

FIG. 3 is a diagram 300 displaying the historization system structure in a slightly different way from FIG. 2. An HCAL 306 is hosted on an application server computer 302 and connected to a historian computer 304 and a store forward process 308. The HCAL 306 connects to the historian through a server side module known as the Historian Client Access Point (HCAP) 312. The HCAP 312 has a variety of functions, including sending data received from HCAL 306 to be stored in history blocks 320. The HCAP 312 also serves to report statistics to a configuration service process 314 and retrieve historian data from a retrieval service process 318.

The HCAL 306 connects to the store forward process 308 through a storage engine used to control the store forward process. The Storage Engine enables the HCAL 306 to store and retrieve snapshots and metadata 310 of the data being collected and sent to the historian. In an embodiment, the store forward process 308 on the application server computer 302 is a child Storage Engine process 308 related to a main Storage Engine process 316 running on the historian computer 304.

In addition, HCAL 306 provides functions to connect to the historian computer 304 either synchronously or asynchronously. On successful call of the connection function, a connection handle is returned to client. The connection handle can then be used for other subsequent function calls related to this connection. The HCAL 306 allows its client to connect to multiple historians. In an embodiment, an “OpenConnection” function is called for each historian. Each call returns different connection handle associated with the connection. The HCAL 306 is responsible for establishing and maintaining the connection to the historian computer 304. While connected, HCAL 306 pings the historian computer 304 periodically to keep the connection alive. If the connection is broken, HCAL 306 will also try to restore the connection periodically.

In an embodiment, HCAL 306 connects to the historian computer 304 synchronously. The HCAL 306 returns a valid connection handle for a synchronous connection only when the historian computer 304 is accessible and other requirements such as authentication are met.

In an embodiment, HCAL 306 connects to the historian computer 304 asynchronously. Asynchronous connection requests are configured to return a valid connection handle even when the historian 304 is not accessible. Tags and data can be sent immediately after the connection handle is obtained. When disconnected from the historian computer 304, they will be stored in the HCAL's local cache while HCAL 306 tries to establish the connection.

In an embodiment, multiple clients connect to the same historian computer 304 through one instance of HCAL 306. An application engine has a historian primitive sending data to the historian computer 304 while an object script can use the historian software development kit (SDK) to communicate with the same historian 304. Both are accessing the same HCAL 306 instance in the application engine process. These client connections are linked to the same server object. HCAL Parameters common to the destination historian, such as those for store forward, are shared among these connections. To avoid conflicts, certain rules have to be followed.

In the order of connections made, the first connection is treated as the primary connection and connections formed after the first are secondary connections. Parameters set by the primary connection will be in effect until all connections are closed. User credentials of secondary connections have to match with those of the primary connection or the connection will fail. Store Forward parameters can only be set in the primary connection. Parameters set by secondary connections will be ignored and errors returned. Communication parameters such as compression can only be set by the primary connection. Buffer memory size can only be set by the primary connection.

The HCAL 306 provides an option called store/forward to allow data be sent to local storage when it is unable to send to the historian. The data will be saved to a designated local folder and later forwarded to the historian.

The client 302 enables store/forward right after a connection handle is obtained from the HCAL 306. The store/forward setting is enabled by calling a HCAL 306 function with store/forward parameters such as the local folder name.

The Storage Engine 308 handles store/forward according to an embodiment of the invention. Once store/forward is enabled, a Storage Engine process 316 will be launched for a target historian 304. The HCAL 306 keeps Storage Engine 308 alive by pinging it periodically. When data is added to local cache memory it is also added to Storage Engine 308. A streamed data buffer will be sent to Storage Engine 308 only when the HCAL 306 detects that it cannot send to the historian 304.

If store/forward is not enabled, streamed data values cannot be accepted by the HCAL 306 unless the tag associated with the data value has already been added to the historian 304. All values will be accumulated in the buffer and sent to the historian 304. If connection to the historian 304 is lost, values will be accepted until all buffers are full. Errors will be returned when further values are sent to the HCAL 306.

The HCAL 306 can be used by OLEDB or SDK applications for data retrieval. The client issues a retrieval request by calling the HCAL 306 with specific information about the query, such as the names of tags for which to retrieve data, start and end time, retrieval mode, and resolution. The HCAL 306 passes the request on to the historian 304, which starts the process of retrieving the results. The client repeatedly calls the HCAL 306 to obtain the next row in the results set until informed that no more data is available. Internally, the HCAL 306 receives compressed buffers containing multiple row sets from the historian 304, which it decompresses, unpacks and feeds back to the user one row at a time. Advantageously, network round trips are kept to a minimum. The HCAL 306 supports all modes of retrieval exposed by the historian.

In an embodiment, the storage engine is decoupled from writing and reading file functionality using a Historian Storage Abstraction Layer (HSAL) over an interface such as IDataVault. It allows the storage engine to use any implementation of the IDataVault or other similar interfaces. Possible implementations include a standard file system implementation (for example, WINDOWS File I/O) and a page blob implementation (for example, WINDOWS AZURE STORAGE).

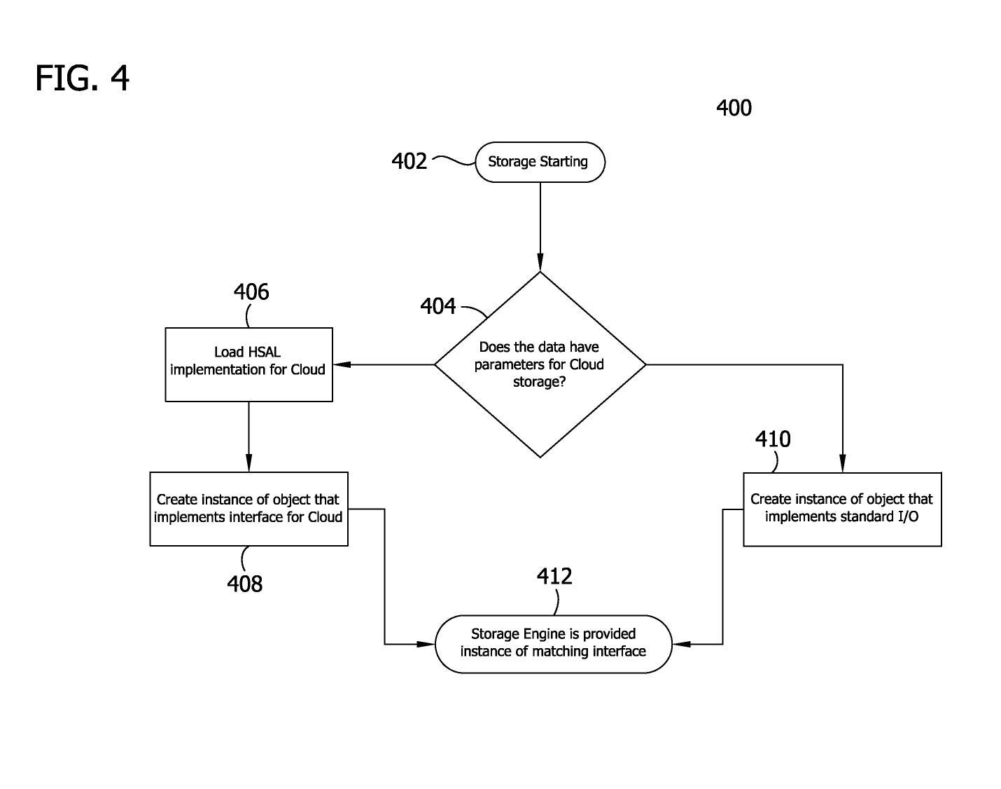

Depending on input parameters, a storage engine creates and uses the first of the second implementation. The flowchart 400 in FIG. 4 demonstrates the functionality of the system determining which implementation of the storage type interface to use. Upon starting the storage process (step 402), the system determines if there are input parameters enabling a cloud-based interface, such as a page blob implementation (step 404). If there are input parameters for a cloud-based storage type interface, the system loads a HSAL library (step 406) that enables interfacing with cloud storage and creates an instance of a data object that implements the interface for a cloud-based storage format, such as page blob format (step 408). If there are not input parameters for cloud-based storage, the system creates an instance of a data object that implements the interface using a standard file system (step 410). The created instance objects are then passed to the storage engine for storage (step 412). By default if no parameters are specified, the Storage Engine uses a standard file system. Some specified parameters may indicate the use of page blob storage, such as Storage Account Name, Access Key, or Container Name.

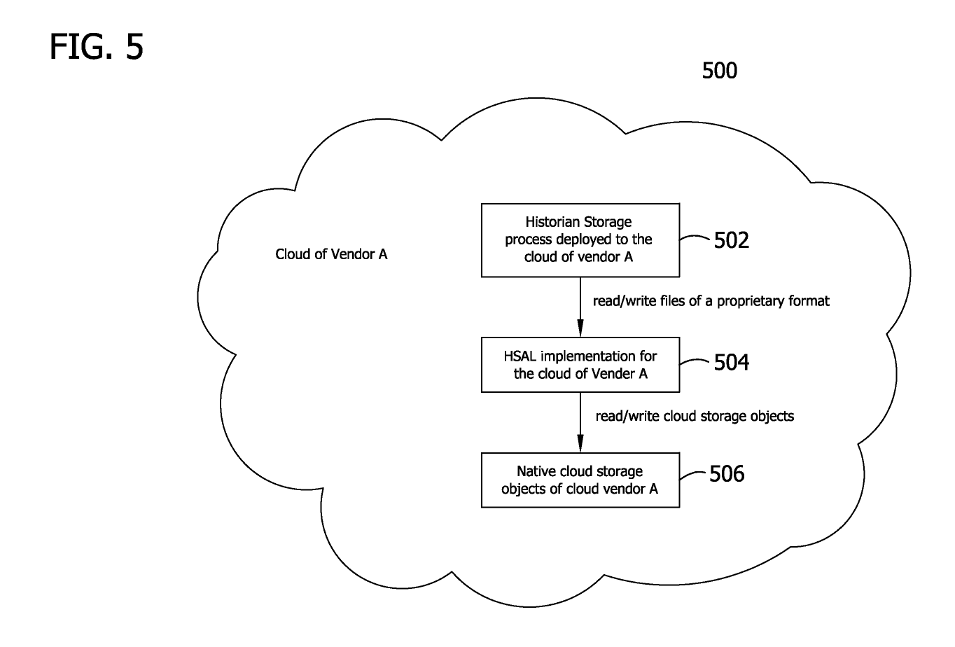

FIG. 5 shows a diagram 500 of HSAL 504 working with page blobs 506. Page blobs 506 are advantageous because they support random access for writing and reading operations. The HSAL 504 works with page blobs 506 using the same logic as with files. HSAL 504 converts all requests from the storage engine 502 to a representational state transfer protocol (REST) and sends it to page blob storage. In an embodiment, HSAL 504 supports directories as a file system. Directory names are included in the names of page blobs 506. For example, a page blob 506 can have the name “Trace\File 1.log”. The storage engine 502 works with a directory file system and it will place File 1.log in the Trace folder.

In an embodiment, the HSAL supports a variety of operations, including a ‘create blob’ operation, a ‘read’ operation, a ‘write’ operation, a ‘move blob’ operation, a ‘delete blob’ operation, a ‘get last modification time of blob’ operation, and a ‘get blob size’ operation. Other operations may also be available.

In an embodiment, the HSAL uses REST API for communication with page blob storage. Using this API, the HSAL concurrently uploads multiple pages of the same blob to increase performance.

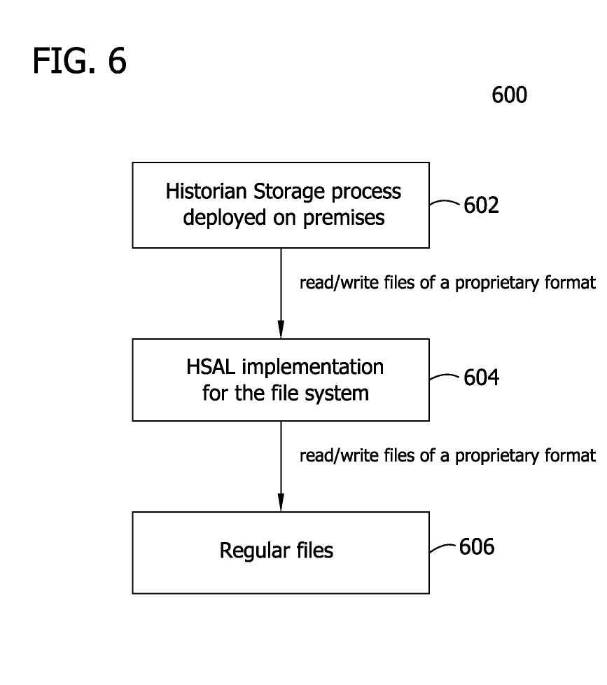

In an embodiment, different storage subsystems may work with the same files or page blobs. FIG. 6 shows a diagram 600 of HSAL 604 working with regular files 606. HSAL 604 converts all requests from the on premise storage engine 602 to another proprietary file format and sends it to file storage 606.

The storage engine has to control sharing access to the same file. HSAL enables access sharing using the same method as a standard file I/O API. For example, if a file was opened for writing and provided only a flag to share it for reading then no other subsystem could open the file for writing.

An interface defines a hierarchical object model for the historian system. The implementation can be abstracted to separate out communication and data access from business logic.

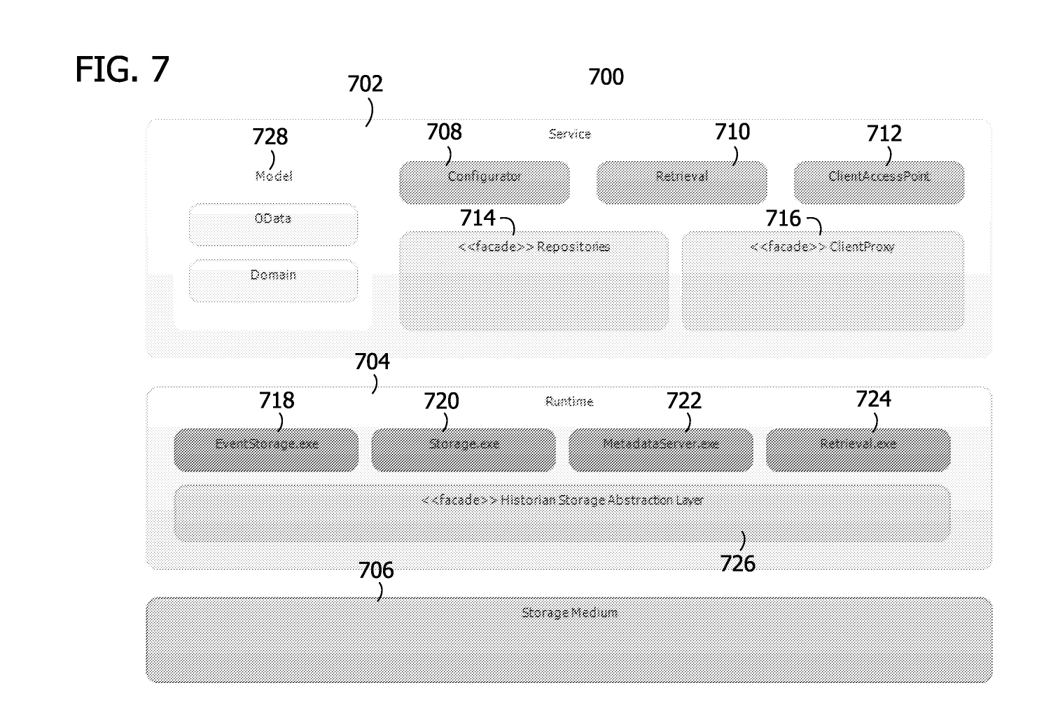

FIG. 7 shows a diagram 700 of the components in each layer of a historian retrieval system. The hosting components in service layer 702 include a configurator 708, a retrieval component 710, and a client access point 712. There are simple processes that are responsible for injecting the facades into the model and have minimal logic beyond configuration of the libraries and expose communication endpoints to external networks. The hosting components could be the same or different implementation for cloud and on premises. In FIG. 7, there are three integration points for cloud and on premise implementation. A repository 714 is responsible for communicating with data storage such as runtime database or configuration table storage components. A client proxy 716 is responsible for communicating with run-time nodes. An HSAL 726, which is present in runtime layer 704, is responsible for reading and writing to a storage medium 706 as described above. The service layer 702 further includes a model module 728.

In addition to the HSAL 726, the runtime layer 704 includes a component for event storage 718, a storage component 720, a metadata server 722, and a retrieval component 724.

In an embodiment, for tenants and data sources, the repositories 714 serve as interfaces that will read and write data using either page blob table storage or an SQL Server database. For tags, process values and events, the repositories 714 act as thin wrappers around the client proxy 716. The client proxy 716 will use the correct communication channel and messages to send data to the runtime engine 704. The historian storage abstraction layer 726 is an interface that mimics an I/O interface for reading and writing byte arrays. The actual implementation will either write to disk or page blob storage as described above.

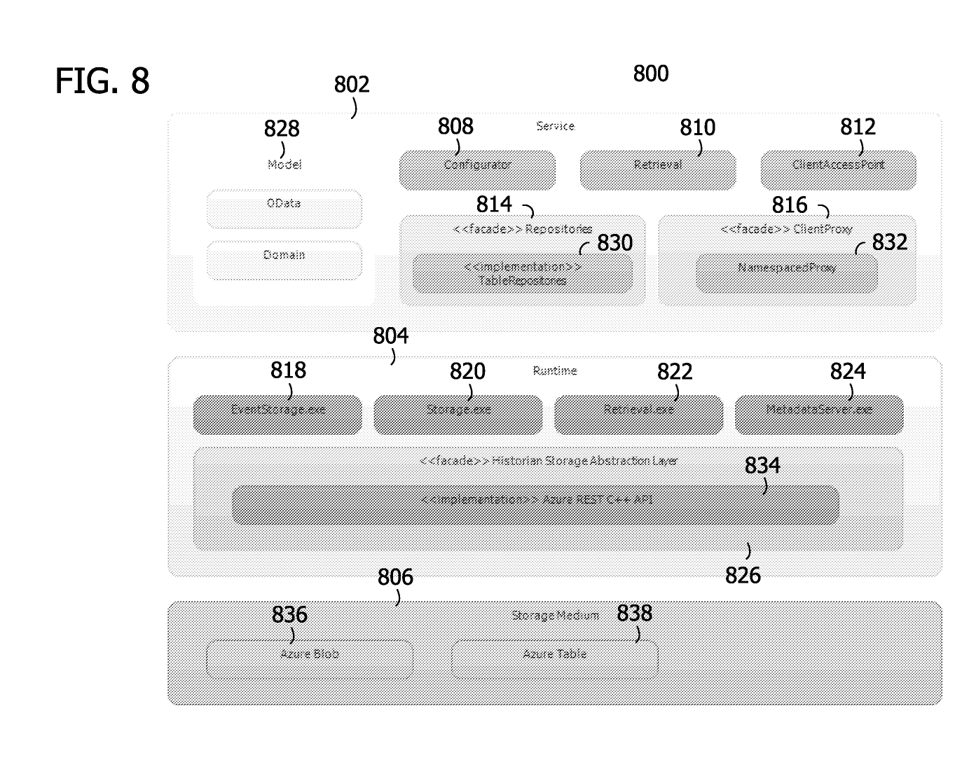

Referring to FIG. 8, the majority of the same components in FIG. 7 are present with a few more included details. For the cloud interface, the repository 814 implementation for tenant and data source is a data access library for table storage 830. The configurator 808 also handles provisioning of tenant and data source. For the client proxy 816, the version of query parameters that make use of namespaces are used (See Namespaced Proxy 832). The namespace query parameter contains tenant ID as the namespace, and storage account credentials are passed along to the runtime engine 804. The runtime engine 804 picks different storage abstraction layers 826 to use depending on whether a namespaced proxy 832 is used or not. In an embodiment making use of the cloud, the HSAL uses REST API 834 to communicate with Azure Blob to store process value blocks or event blocks on the storage medium 806. Data is also stored within, for example, Azure Tables 838.

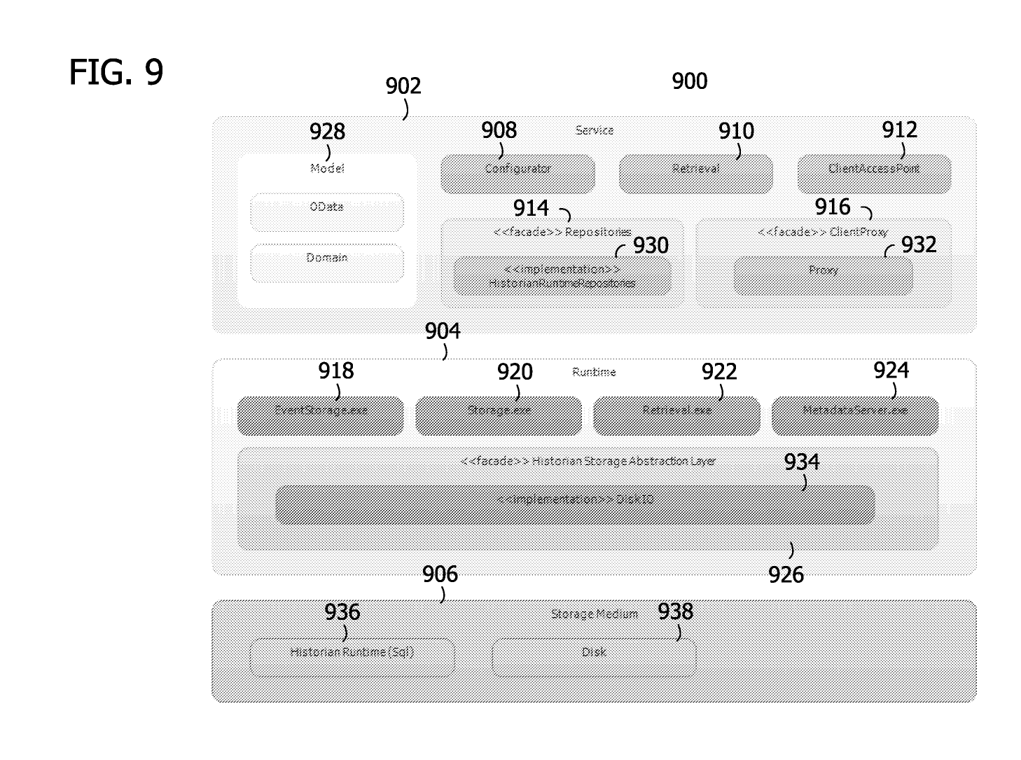

Similar to FIG. 8, FIG. 9 illustrates the majority of the same components as described with respect to FIG. 7. For the on premises implementation as shown in FIG. 9, the namespaces discussed above are not necessary. The on premises application server does not need to provide namespace information to the historian and when the interface is implemented for the on premises historian, it has a flat structure of a single tenant and a single data source. Repositories 914 comprise standard runtime repositories 930 and a client proxy component 916 comprises a standard proxy module 932. An HSAL 926 uses a standard disk I/O 934 for communicating data with a storage medium 906. The storage medium does not make use of Azure Blobs or Azure Tables, but instead uses a simple historian runtime SQL module 936 and a standard disk 938 in this embodiment.

The Abstract and summary are provided to help the reader quickly ascertain the nature of the technical disclosure. They are submitted with the understanding that they will not be used to interpret or limit the scope or meaning of the claims. The summary is provided to introduce a selection of concepts in simplified form that are further described in the Detailed Description. The summary is not intended to identify key features or essential features of the claimed subject matter, nor is it intended to be used as an aid in determining the claimed subject matter.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention is not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and process without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

What is claimed is:

1. A historization system enabling storage of data to multiple locations having multiple storage types comprising:
a historian server;
a first memory device coupled to the historian server;
a historian storage module stored on the memory device and executed on the historian server, the historian storage module comprising an abstraction layer module; and
one or more storage locations communicatively coupled to the historian storage device;
wherein the historian storage module comprises processor executable instructions for:
beginning the historian storage process;
receiving data to be stored;
determining a storage type for the received data; and
loading the abstraction layer module with the received data and the determined storage type;
wherein the abstraction layer module comprises processor executable instructions for:
storing implementations of one or more storage type interfaces;
receiving data to be stored and storage type from the historian storage module;
determining a storage type interface which matches the received storage type from the one or more storage type interfaces;
formatting the received data to the matching storage type interface;
determining a storage location that matches the received storage type from the one or more storage locations; and
sending formatted data to be stored at the matching storage location via the matching storage type interface.

2. The historization system of claim 1, wherein the storage type of the received data is determined based on input parameters of the received data.

3. The historization system of claim 2, wherein the input parameters include a tenant ID identifying from which tenant the data has been received and storage account credentials for verifying the received data.

4. The historization system of claim 1, wherein the storage type of the received data is determined to be a standard file system.

5. The historization system of claim 1, wherein the storage type of the received data is determined to be a cloud-based storage interface.

6. The historization system of claim 5, wherein the storage type of the received data is determined to be a page blob implementation.

7. The historization system of claim 6, wherein the cloud-based storage interface comprises an REST API.

8. The historization system of claim 1, wherein the matching storage location is determined to be a cloud-based storage location.

9. The historization system of claim 1, wherein the matching storage location is determined to be an on-premises storage location.

10. The historization system of claim 1, wherein the abstraction layer module enables a storage type interface comprising a directory file system.

11. A historization method enabling storage of data to multiple locations with multiple storage types comprising:
loading an abstraction layer module with data to be stored and a determined storage type;
storing implementations of one or more storage type interfaces;
determining a storage type interface that matches the storage type from the one or more storage type interfaces;
formatting the data to the matching storage type interface;
determining a storage location that matches the storage type from one or more storage locations; and
sending formatted data to be stored at the matching storage location via the matching storage type interface;

12. The historization method of claim 11, wherein the storage type of the data is determined based on input parameters of the data.

13. The historization method of claim 12, wherein the input parameters include a tenant ID identifying from which tenant the data has been received and storage account credentials for verifying the data.

14. The historization method of claim 11, wherein the storage type of the data is determined to be a standard file system.

15. The historization method of claim 11, wherein the storage type of the data is determined to be a cloud-based storage interface.

16. The historization method of claim 15, wherein the storage type of the data is determined to be a page blob implementation.

17. The historization method of claim 16, wherein the cloud-based storage interface comprises an REST API.

18. The historization method of claim 11, wherein the matching storage location is determined to be a cloud-based storage location.

19. The historization method of claim 11, wherein the matching storage location is determined to be an on-premises storage location.

20. The historization method of claim 11, wherein the abstraction layer module enables a storage type interface comprising a directory file system.
